(19) United States
(12) Patent Application Publication
(10) Pub. No.: US 2026/0104734 A1
(43) Pub. Date: Apr. 16, 2026

(54) SMART RING CLIP AND METHOD OF MANUFACTURE

(71) Applicant: Quanata, LLC, San Francisco, CA (US)

(72) Inventor: Kenneth Jason Sanchez, San Francisco, CA (US)

(73) Assignee: Quanata, LLC, San Francisco, CA (US)

(21) Appl. No.: 19/421,136

(22) Filed: Dec. 16, 2025

Related U.S. Application Data
(63) Continuation of application No. 16/927,402, filed on Jul. 13, 2020, now Pat. No. 12,504,784.
(60) Provisional application No. 62/877,391, filed on Jul. 23, 2019.
(60) Provisional application No. 62/986,905, filed on Mar. 9, 2020.

(51) Int. Cl. G06F 1/16; B33Y 50/00; B33Y 80/00; G06F 3/01; H04N 1/00; H04W 4/80

(52) U.S. Cl. CPC G06F 1/163; B33Y 50/00; B33Y 80/00; G06F 3/014; H04N 1/00233; H04N 1/00278; H04N 1/00827; H04N 2201/0081; H04W 4/80

(57) ABSTRACT

A ring clip includes a body. The ring clip also can include a groove disposed within the body and extending along a length of the body between a first end and a second end of the ring clip. The groove can be configured to receive a ring having a conventional ring shape. The body of the ring clip can be removable from the ring. The ring clip further can include a sensor configured to collect information from a user. The first portion of an outside surface of the body can include a location that is outside of the groove. The first portion of the outside surface of the body can include a location that is not configured to contact a finger of the user when the ring clip is coupled to the ring and when the ring is worn on the finger of the user. Other embodiments are disclosed herein.

### CROSS-REFERENCES TO RELATED APPLICATIONS

This application is a continuation of U.S. Non-Provisional patent application Ser. No. 16/927,402, filed Jul. 13, 2020, which claims priority to U.S. Provisional Patent Application No. 62/877,391, filed Jul. 23, 2019, and U.S. Provisional Patent Application No. 62/986,905, filed Mar. 9, 2020, all of which are incorporated by reference herein for all purposes.

### FIELD OF THE DISCLOSURE

The present disclosure generally relates to implementations of smart ring wearable devices.

### BACKGROUND

To the extent that smart ring technology has been adopted, it has a number of challenges. Problems with wearable rings include: they generally need to be removed for charging; they have poor fit; they provide relatively little interactivity; and they provide limited functionality, in general.

### BRIEF SUMMARY

This disclosure describes a number of improvements to smart ring technology. Specifically, this disclosure describes multiple techniques for charging smart rings (including harvesting energy, improving wireless charging, improving battery configurations, and increasing functionality while maintaining substantively low energy consumption).

Further, the described techniques include: techniques for measuring and analyzing biometrics; techniques for enabling a variety of security features using smart rings; techniques for improving smart ring form factors; and techniques for using gesture recognition and improving interactivity of smart rings.

According to one aspect of the present disclosure, a smart ring clip comprises a body with a groove for receiving a portion of a ring, and the portion of the ring contacts the body, and the body includes a flexible material. One or more of a battery, a charging unit, a processing unit, a user input unit, a communication unit, a memory unit, at least one sensor unit, and an output unit is one of attached to or disposed within the body. So configured, the body is secured to the ring by the groove and removable from the portion of the ring upon movement of the body in a direction away from the ring.

According to another aspect of the present disclosure, a method of manufacturing a smart ring clip comprises creating a body with a flexible material by one of heat molding, injection molding, ink printing, stamping, metal forming, machining, or additive manufacturing, and creating a groove disposed within the body by one of heat molding, injection molding, ink printing, stamping, metal forming, machining, or additive manufacturing. The groove is for receiving a portion of a ring, and the ring contacts the body. The method further comprises disposing one or more of a battery, a charging unit, a processor unit, a user input unit, a communication unit, a memory unit, at least one sensor unit, an output unit or a user input unit in or on one or more of the body or a housing portion separate from and coupled to the body.

According to yet another aspect of the present disclosure, a system for additively manufacturing a smart ring clip comprises a communication network and a scanning device communicatively coupled to the communication network. The scanning device includes a memory and at least one processor, and the at least one processor of the scanning device executes a scanning module stored on the memory of the scanning device to create a ring-specific scan of a ring to which the smart ring clip is to be attached. The system further comprises a 3D printer communicatively coupled to the communication network and a design system having a computing device communicatively coupled to the communication network, the scanning device, and the 3D printer. The computing device of the design system has a memory, at least one processor, a transmitter, and a receiver, and the computing device receives data from the scanning device relating to the ring-specific scan. The system further includes a module that is stored in the memory of the computing device of the design system and executable by the at least one processor of the computing device of the design system to: (1) receive data from the scanning device relating to the ring-specific scan; and (2) create a ring-specific smart ring clip profile based at least in part on the data received from the scanning device. The ring-specific smart ring clip profile is configured to be transmitted to the 3D printer to implement the ring-specific smart ring clip profile. So configured, the scanning device creates the ring-specific scan and the 3D printer receives the ring-specific smart ring profile from the computing device of the design center and implements the ring-specific smart ring profile to additively manufacture a smart ring clip. The smart ring clip comprises a body with a groove for receiving a portion of the ring, the ring contacts the body, the body includes flexible material. Further, one or more of a battery, a charging unit, a processing unit, a user input unit, a communication unit, a memory unit, at least one sensor unit, and an output unit one of attached to or disposed within the body.

In further accordance with any one or more of the exemplary aspects, the smart ring clip, the method of manufacturing a smart ring clip, the system for additively manufacturing a smart ring clip or any other method or system of the present disclosure may include any one or more of the following preferred forms and/or methods.

According to one form, the body may include a first end and a second end disposed opposite the first end, and the groove may extend along the length of the body between the first end and the second end.

According to another form, the body may further comprise an inside surface configured to contact the ring, and the inside surface may have one or more of an output element and a sensor.

According to yet another form, the body may further comprise an outside surface, and the outside surface may have one or more of an output element and a sensor.

In another form, the body may include one of a semi-circular shape, a partially circular shape, or a partially semi-circular shape.

In another form, the smart ring clip may further comprise a housing portion removably coupled to an outside surface of the body. The housing portion may include one or more of the battery, the charging unit, the processing unit, the user input unit, the communication unit, the memory unit, the sensor unit, and the output unit.

In yet another form, one or more of a portion of the body or the entire body nay comprise an electric sensor fabric material.

In another form, a portion of the body may include a silicone material configured to function as part of one of an artificial muscle or a nerve, and the silicone material may be capable of one or more of generating electricity or sensing pressure.

In yet another form, the body may be one or more of additively manufactured or heat molded to a ring of a user obtained by one or more of scanning or photographing a portion of the ring or a mold indicative of the ring of the user to which the smart ring clip will be attached.

According to one method, the method may comprise coupling a housing portion to the additively manufactured body of the smart ring clip, and the housing portion may include one or more of a battery, a charging unit, a processing unit, a user input unit, a communication unit, a memory unit, at least one sensor unit, an output unit or a user input unit.

In another method, the method may further comprise disposing one or more of a sensor or an output element on an inside surface of the body.

In still another method, the method may further comprise disposing one or more of a sensor or an output element on an outside surface of the body.

In yet another method, creating a body with a flexible material by one of heat molding, injection molding, ink printing, stamping, metal forming, machining, or additive manufacturing may comprise creating a body with a flexible material and having one or more of a partially semi-circular shape or a semi-circular shape.

In another method, creating a body with flexible material by one of heating molding, injection molding, ink printing, stamping, metal forming, machining, or additive manufacturing may comprise creating a body having a first end and a second end and an inside surface disposed between the first end and the second end.

In another method, creating a groove disposed within the body by one of heat molding, injection molding, ink printing, stamping, metal forming, machining, or additive manufacturing may comprise creating a groove extending between the first end and the second end along the length of the body.

In another form, the scanning device may further comprise a transmitter and a receiver, and the transmitter may transmit the scanning data to the computing device of the design center.

In still another form, the 3D printer may have a memory, at least one processor, a transmitter and a receiver, and the receiver of the 3D printer may receive the ring-specific smart ring clip profile from the computing device of the design center and the at least one processor of the 3D printer executing the ring-specific smart ring clip profile to additively manufacture the body of the smart ring clip.

In another form, the scanning device may be a volumetric capture sensor.

In another embodiment, a ring clip includes a body. The ring clip also can include a groove disposed within the body and extending along a length of the body between a first end and a second end of the ring clip. The groove can be configured to receive a ring having a conventional ring shape. The body of the ring clip can be removable from the ring. The ring clip further can include a sensor configured to collect information from a user. A first portion of an outside surface of the body can include a location that is outside of the groove. The first portion of the outside surface of the body can include a location that is not configured to contact a finger of the user when the ring clip is coupled to the ring and when the ring is worn on the finger of the user. A second portion of the outside surface of the body can include a location that is outside of the groove. The second portion of the outside surface of the body also can include a location that is configured to contact the finger of the user when the ring clip is coupled to the ring and when the ring is worn on the finger of the user.

In another embodiment, a method of providing a ring clip can include providing a body. The method of providing the ring clip also can include providing a groove disposed within the body and extending along a length of the body between a first end and a second end of the ring clip. The groove can be configured to receive a ring having a conventional ring shape. The body of the ring clip can be removable from the ring. The method of providing the ring clip further can include providing a sensor configured to collect information from a user. A first portion of an outside surface of the body can include a location outside of the groove. The first portion of the outside surface of the body also can include a location not configured to contact a finger of the user when the ring clip is coupled to the ring and when the ring clip is worn on the finger of the user. A second portion of the outside surface of the body can include a location that is outside of the groove. The second portion of the outside surface of the body also can include a location that is configured to contact the finger of the user when the ring clip is coupled to the ring and when the ring is worn on the finger of the user.

In another embodiment, a method of manufacturing a ring clip can include creating a body. The method of manufacturing the ring clip also can include creating a groove disposed within the body and extending along a length of the body between a first end and a second end of the ring clip. The groove can be configured to receive a ring having a conventional ring shape. The body of the ring clip can be removable from the ring. The method of manufacturing the ring clip further can include disposing a sensor configured to collect information from a user. A first portion of an outside surface of the body can include a location that is outside of the groove. The first portion of the outside surface of the body can include a location that is not configured to contact a finger of the user when the ring clip is coupled to the ring and when the ring is worn on the finger of the user. A second portion of the outside surface of the body can include a location that is outside of the groove. The second portion of the outside surface of the body also can include a location that is configured to contact the finger of the user when the ring clip is coupled to the ring and when the ring is worn on the finger of the user.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 illustrates a system comprising a smart ring and a block diagram of smart ring components according to some embodiments.

FIG. 2 illustrates a number of different form factor types of a smart ring according to some embodiments.

FIG. 3 illustrates examples of different smart ring form factors.

FIG. 4 illustrates an environment within which a smart ring may operate according to some embodiments.

FIG. 5 is a view of a smart ring clip of FIG. 2 according to some embodiments.

FIG. 6 is a view of another smart ring clip of FIG. 2 according to some embodiments.

FIG. 7 is a view of a portion of a smart ring clip of FIG. 3 according to some embodiments.

FIG. 8 is a perspective view of a system for manufacturing a smart ring according to an aspect of the present disclosure.

FIG. 9 is a block diagram of a portion of the system of FIG. 8 according to some embodiments.

### DETAILED DESCRIPTION

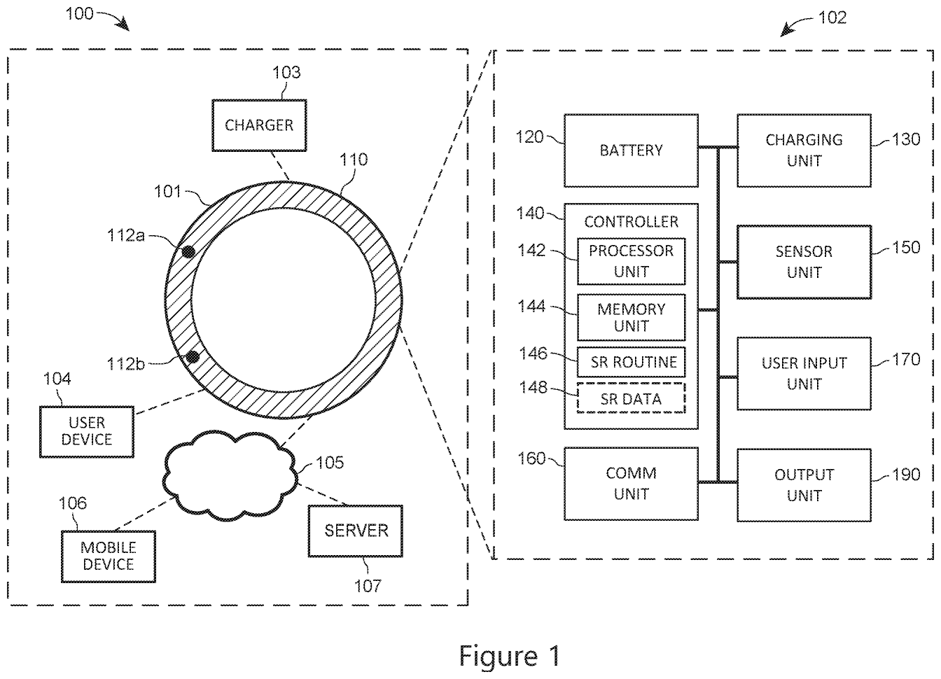

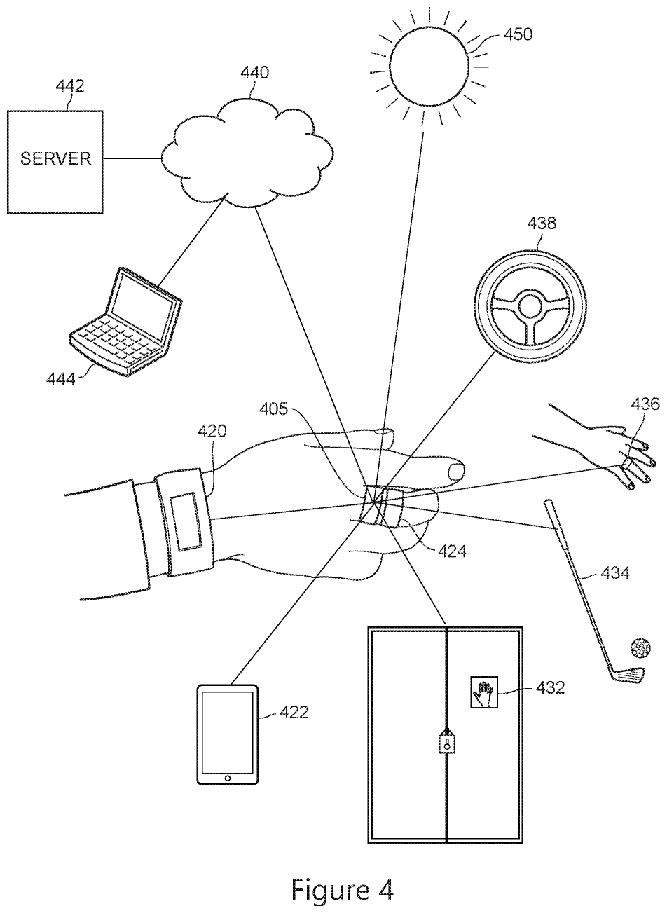

FIG. 1 illustrates a system 100 comprising (i) a smart ring 101 including a set of components 102 and (ii) one or more devices or systems that may be electrically, mechanically, or communicatively connected to the smart ring 101. Specifically, the system 100 may comprise any one or more of: a charger 103 for the smart ring 101, a user device 104, a network 105, a mobile device 106, or a server 107. The charger 103 may provide energy to the smart ring 101 by way of a direct electrical, a wireless, or an optical connection. The smart ring 101 may be in a direct communicative connection with the user device 104, the mobile device 106, or the server 107 by way of the network 105. Interactions between the smart ring 101 and other components of the system 100 are discussed in more detail in the context of FIG. 4.

The smart ring 101 may sense a variety of signals indicative of activities of a user wearing the ring 101, biometric signals, a physiological state of the user, or signals indicative of the user's environment. The smart ring 101 may analyze the sensed signals using built-in computing capabilities or in cooperation with other computing devices (e.g., user device 104, mobile device 106, server 107) and provide feedback to the user or about the user via the smart ring 101 or other devices (e.g., user device 104, mobile device 106, server 107). Additionally or alternatively, the smart ring 101 may provide the user with notifications sent by other devices, enable secure access to locations or information, or a variety of other applications pertaining to health, wellness, productivity, or entertainment.

The smart ring 101, which may be referred to herein as the ring 101, may comprise a variety of mechanical, electrical, optical, or any other suitable subsystems, devices, components, or parts disposed within, at, throughout, or in mechanical connection to a housing 110 (which may be ring shaped and generally configured to be worn on a finger). Additionally, a set of interface components 112a and 112b may be disposed at the housing, and, in particular, through the surface of the housing. The interface components 112a and 112b may provide a physical access (e.g., electrical, fluidic, mechanical, or optical) to the components disposed within the housing. The interface components 112a and 112b may exemplify surface elements disposed at the housing. As discussed below, some of the surface elements of the housing may also be parts of the smart ring components.

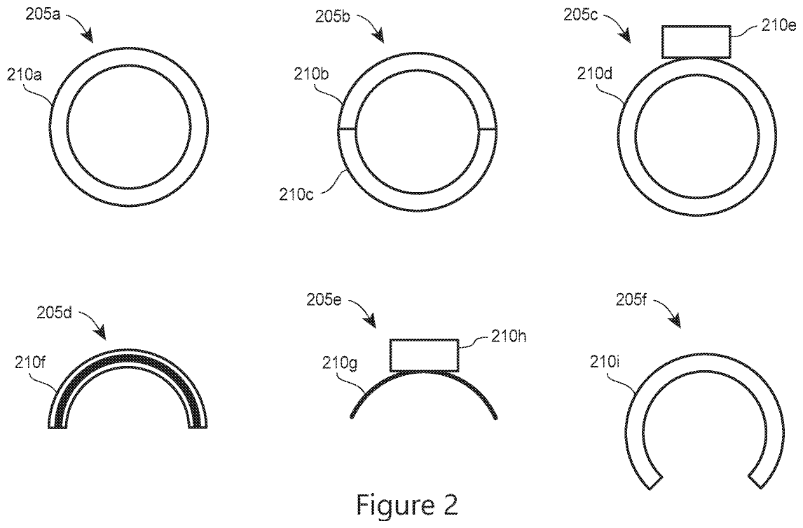

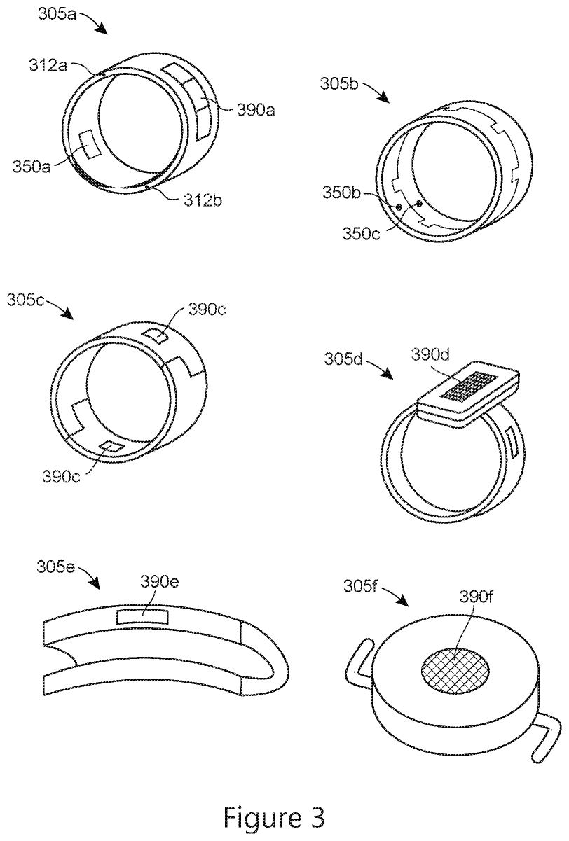

As shown in FIG. 1, the components 102 of the smart ring 101 may be distributed within, throughout, or on the housing 110. As discussed in the contexts of FIG. 2 and FIG. 3 below, the housing 110 may be configured in a variety of ways and include multiple parts. The smart ring components 102 may, for example, be distributed among the different parts of the housing 110, as described below, and may include surface elements of the housing 110. The housing 110 may include mechanical, electrical, optical, or any other suitable subsystems, devices, components, or parts disposed within or in mechanical connection to the housing 110, including a battery 120, a charging unit 130, a controller 140, a sensor system 150 comprising one or more sensors, a communications unit 160, a one or more user input devices 170, or a one or more output devices 190. Each of the components 120, 130, 140, 150, 160, 170, and/or 190 may include one or more associated circuits, as well as packaging elements. The components 120, 130, 140, 150, 160, 170, and/or 190 may be electrically or communicatively connected with each other (e.g., via one or more busses or links, power lines, etc.), and may cooperate to enable “smart” functionality described within this disclosure.

The battery 120 may supply energy or power to the controller 140, the sensors 150, the communications unit 160, the user input devices 170, or the output devices 190. In some scenarios or implementations, the battery 120 may supply energy or power to the charging unit 130. The charging unit 130, may supply energy or power to the battery 120. In some implementations, the charging unit 130 may supply (e.g., from the charger 103, or harvested from other sources) energy or power to the controller 140, the sensors 150, the communications unit 160, the user input devices 170, or the output devices 190. In a charging mode of operation of the smart ring 101, the average power supplied by the charging unit 130 to the battery 120 may exceed the average power supplied by the battery 120 to the charging unit 130, resulting in a net transfer of energy from the charging unit 130 to the battery 120. In a non-charging mode of operation, the charging unit 130 may, on average, draw energy from the battery 120.

The battery 120 may include one or more cells that convert chemical, thermal, nuclear or another suitable form of energy into electrical energy to power other components or subsystems 140, 150, 160, 170, and/or 190 of the smart ring 101. The battery 120 may include one or more alkaline, lithium, lithium-ion and or other suitable cells. The battery 120 may include two terminals that, in operation, maintain a substantially fixed voltage of 1.5, 3, 4.5, 6, 9, 12 V or any other suitable terminal voltage between them. When fully charged, the battery 120 may be capable of delivering to power-sinking components an amount of charge, referred to herein as “full charge,” without recharging. The full charge of the battery may be 1, 2, 5, 10, 20, 50, 100, 200, 500, 1000, 2000, 5000 mAh or any other suitable charge that can be delivered to one or more power-consuming loads as electrical current.

The battery 120 may include a charge-storage device, such as, for example a capacitor or a super-capacitor. In some implementations discussed below, the battery 120 may be entirely composed of one or more capacitive or charge-storage elements. The charge storage device may be capable of delivering higher currents than the energy-conversion cells included in the battery 120. Furthermore, the charge storage device may maintain voltage available to the components or subsystems 130, 150, 160, 170, and/or 190 when one or more cells of the battery 120 are removed to be subsequently replaced by other cells.

The charging unit 130 may be configured to replenish the charge supplied by the battery 120 to power-sinking components or subsystems (e.g., one or more of subsystems 130, 150, 160, 170, and/or 190) or, more specifically, by their associated circuits. To replenish the battery charge, the charging unit 130 may convert one form of electrical energy into another form of electrical energy. More specifically, the charging unit 130 may convert alternating current (AC) to direct current (DC), may perform frequency conversions of current or voltage waveforms, or may convert energy stored in static electric fields or static magnetic fields into direct current. Additionally or alternatively, the charging unit 130 may harvest energy from radiating or evanescent electromagnetic fields (including optical radiation) and convert it into the charge stored in the battery 120. Furthermore, the charging unit 130 may convert non-electrical energy into electrical energy. For example, the charging unit 130 may harvest energy from motion, or from thermal gradients.

The controller 140 may include a processor unit 142 and a memory unit 144. The processor unit 142 may include one or more processors, such as a microprocessor (μP), a digital signal processor (DSP), a central processing unit (CPU), a graphical processing unit (GPU), a field-programmable gate array (FPGA), an application-specific integrated circuit (ASIC), or any other suitable electronic processing components. Additionally or alternatively, the processor unit 142 may include photonic processing components.

The memory unit 144 may include one or more computer memory devices or components, such as one or more registers, RAM, ROM, EEPROM, or on-board flash memory. The memory unit 144 may use magnetic, optical, electronic, spintronic, or any other suitable storage technology. In some implementations, at least some of the functionality the memory unit 144 may be integrated in an ASIC or and FPGA. Furthermore, the memory unit 144 may be integrated into the same chip as the processor unit 142 and the chip, in some implementations, may be an ASIC or an FPGA.

The memory unit 144 may store a smart ring (SR) routine 146 with a set of instructions, that, when executed by the processor 142 may enable the operation and the functionality described in more detail below. Furthermore, the memory unit 144 may store smart ring (SR) data 148, which may include (i) input data used by one or more of the components 102 (e.g., by the controller when implementing the SR routine 146) or (ii) output data generated by one or more of the components 102 (e.g., the controller 140, the sensor unit 150, the communication unit 160, or the user input unit 170). In some implementations, other units, components, or devices may generate data (e.g., diagnostic data) for storing in the memory unit 144.

The processing unit 142 may draw power from the battery 120 (or directly from the charging unit 130) to read from the memory unit 144 and to execute instructions contained in the smart ring routine 146. Likewise, the memory unit 144 may draw power from the battery 120 (or directly from the charging unit 130) to maintain the stored data or to enable reading or writing data into the memory unit 144. The processor unit 142, the memory unit 144, or the controller 140 as a whole may be capable of operating in one or more low-power mode. One such low power mode may maintain the machine state of the controller 140 when less than a threshold power is available from the battery 120 or during a charging operation in which one or more battery cells are exchanged.

The controller 140 may receive and process data from the sensors 150, the communications unit 160, or the user input devices 170. The controller 140 may perform computations to generate new data, signals, or information. The controller 140 may send data from the memory unit 144 or the generated data to the communication unit 160 or the output devices 190. The electrical signals or waveforms generated by the controller 140 may include digital or analog signals or waveforms. The controller 140 may include electrical or electronic circuits for detecting, transforming (e.g., linearly or non-linearly filtering, amplifying, attenuating), or converting (e.g., digital to analog, analog to digital, rectifying, changing frequency) of analog or digital electrical signals or waveforms.

The sensor unit 150 may include one or more sensors disposed within or throughout the housing 110 of the ring 101. Each of the one or more sensors may transduce one or more of: light, sound, acceleration, translational or rotational movement, strain, temperature, chemical composition, surface conductivity or other suitable signals into electrical or electronic sensors or signals. A sensor may be acoustic, photonic, micro-electro-mechanical systems (MEMS) sensors, chemical, micro-fluidic (e.g., flow sensor), or any other suitable type of sensor. The sensor unit 150 may include, for example, an inertial motion unit (IMU) for detecting orientation and movement of the ring 101.

The communication unit 160 may facilitate wired or wireless communication between the ring 101 and one or more other devices. The communication unit 160 may include, for example, a network adaptor to connect to a computer network, and, via the network, to network-connected devices. The computer network may be the Internet or another type of suitable network (e.g., a personal area network (PAN), a local area network (LAN), a metropolitan area network (MAN), a wide area network (WAN), a mobile, a wired or wireless network, a private network, a virtual private network, etc.). The communication unit 160 may use one or more wireless protocols, standards, or technologies for communication, such as Wi-Fi, near field communication (NFC), Bluetooth, or Bluetooth low energy (BLE). Additionally or alternatively, the communication unit 160 may enable free-space optical or acoustic links. In some implementations, the communication unit 160 may include one or more ports for a wired communication connections. The wired connections used by the wireless communication module 160 may include electrical or optical connections (e.g., fiber-optic, twisted-pair, coaxial cable).

User input unit 170 may collect information from a person wearing the ring 101 or another user, capable of interacting with the ring 101. In some implementations, one or more of the sensors in the sensor unit 150 may act as user input devices within the user input unit 170. User input devices may transduce tactile, acoustic, video, gesture, or any other suitable user input into digital or analog electrical signal, and send these electrical signals to the controller 140.

The output unit 190 may include one or more devices to output information to a user of the ring 101. The one or more output devices may include acoustic devices (e.g., speaker, ultrasonic); haptic (thermal, electrical) devices; electronic displays for optical output, such as an organic light emitting device (OLED) display, a laser unit, a high-power light-emitting device (LED), etc.; or any other suitable types of devices. For example, the output unit 190 may include a projector that projects an image onto a suitable surface. In some implementations, the sensor unit 150, the user input unit 170, and the output unit 190 may cooperate to create a user interface with capabilities (e.g., a keyboard) of much larger computer systems, as described in more detail below.

The components 120, 130, 140, 150, 160, 170, and/or 190 may be interconnected by a bus 195, which may be implemented using one or more circuit board traces, wires, or other electrical, optoelectronic, or optical connections. The bus 195 may be a collection of electrical power or communicative interconnections. The communicative interconnections may be configured to carry signals that conform to any one or more of a variety of protocols, such as I2C, SPI, or other logic to enable cooperation of the various components.

FIG. 2 includes a number of different example form factor types or configurations 205a, 205b, 205c, 205d, 205e, and/or 205f of a smart ring or smart ring clip (e.g., the smart ring 101). The configurations 205a, 205b, 205c, 205d, 205e, and/or 205f (which may also be referred to as the smart rings or smart ring clips 205a, 205b, 205c, 205d, 205e, and/or 205f) may each represent an implementation of the smart ring 101, and each may include any one or more of the components 102 (or components similar to the components 102). In some embodiments, one or more of the components 102 may not be included in the configurations 205a, 205b, 205c, 205d, 205e, and/or 205f. The configurations 205a, 205b, 205c, 205d, 205e, and/or 205f include housings 210a, 210b, 210c, 210d, 210e, and/or body 210f, which may be similar to the housing 110 shown in FIG. 1.

The configuration 205a may be referred to as a band-only configuration comprising a housing 210a. In the configuration 205b, a band may include two or more removably connected parts, such as the housing parts 210b and 210c. The two housing parts 210b and 210c may each house at least some of the components 102, distributed between the housing parks 210b and 210c in any suitable manner.

The configuration 205c may be referred to as a band-and-platform configuration comprising (i) a housing component 210d and (ii) a housing component 210e (sometimes called the “platform 210e”), which may be in a fixed or removable mechanical connection with the housing 210d. The platform 210e may function as a mount for a “jewel” or for any other suitable attachment. The housing component 210d and the platform 210e may each house at least one or more of the components 102 (or similar components).

In some instances, the term “smart ring” may refer to a partial ring that houses one or more components (e.g., components 102) that enable the smart ring functionality described herein. The configurations 205d and 205e may be characterized as “partial” smart rings, and may be configured for attachment to a second ring. The second ring may be a conventional ring without smart functionality, or may be second smart ring, wherein some smart functionality of the first or second rings may be enhanced by the attachment.

The configuration 205d, for example, may include a body 210f with a groove to enable clipping onto a conventional ring. The grooved clip-on body 210f may house the smart ring components described above. The configuration 205e may clip onto a conventional ring using a substantially flat clip 210g part of the body and contain the smart ring components in a platform part of the housing portion 210h.

The configuration 205f, on the other hand, may be configured to be capable of being mounted onto a finger of a user without additional support (e.g., another ring). To that end, the housing 210i of the configuration 205f may be substantially of a partial annular shape subtending between 180 and 360 degrees of a full circumference. When implemented as a partial annular shape, the housing 210i may be more adaptable to fingers of different sizes that a fully annular band (360 degrees), and may be elastic. A restorative force produced by a deformation of the housing 210i may ensure a suitable physical contact with the finger. Additional suitable combinations of configurations (not illustrated) may combine at least some of the housing features discussed above.

FIG. 3 includes perspective views of example configurations 305a, 305b, 305c, 305d, 305e, and/or 305f of a smart ring (e.g., the smart ring 101) in which a number of surface elements are included.

Configuration 305a is an example band configuration 205a of a smart ring (e.g., smart ring 101). Some of the surface elements of the housing may include interfaces 312a, 312b that may be electrically connected to, for example, the charging unit 130 or the communications unit 160. On the outside of the configuration 305a, the interfaces 312a, 312b may be electrically or optically connected with a charger to transfer energy from the charger to a battery (e.g., the battery 120), or with another device to transfer data to or from the ring 305a. The outer surface of the configuration 305a may include a display 390a, while the inner surface may include a biometric sensor 350a.

The configurations 305b and 305c are examples of configurations of a smart ring with multiple housing parts (e.g., configuration 205b in FIG. 2). Two (or more) parts may be separate axially (configuration 305b), azimuthally (configuration 305c), or radially (nested rings, not shown). The parts may be connected mechanically, electrically, or optically via, for example, interfaces analogous to interfaces 312a, 312b in configuration 305a. Each part of a smart ring housing may have one or more surface elements, such as, for example, sensors 350b, 350c or output elements 390b, 390c. The latter may be LEDs (e.g., output element 390b) or haptic feedback devices (e.g., output element 390c), among other suitable sensor or output devices. Additionally or alternatively, at least some of the surface elements (e.g., microphones, touch sensors) may belong to the user input unit 170.

Configuration 305d may be an example of a band and platform configuration (e.g., configuration 205c), while configurations 305e and 305f may be examples of the partial ring configurations 205d and 205e, respectively. Output devices 390d, 390e, and/or 390f on the corresponding configurations 305d, 305e, and/or 305f may be LCD display, OLED displays, e-ink displays, one or more LED pixels, speakers, or any other suitable output devices that may be a part of a suite of outputs represented by an output unit (e.g., output unit 190). Other surface elements, such as an interface component 312c may be disposed within, at, or through the housing. It should be appreciated that a variety of suitable surface elements may be disposed at the illustrated configurations 305a, 305b, 305c, 305d, 305e, and/or 305f at largely interchangeable locations. For example, the output elements 390d, 390e, and/or 390f may be replaced with sensors (e.g., UV sensor, ambient light or noise sensors, etc.), user input devices (e.g., buttons, microphones, etc.), interfaces (e.g., including patch antennas or optoelectronic components communicatively connected to communications units), or other suitable surface elements.

FIG. 4 illustrates an example environment within which a smart ring 405 may be configured to operate. In an embodiment, the smart ring 405 may be the smart ring 101. In some embodiments, the smart ring 405 may be any suitable smart ring capable of providing at least some of the functionality described herein. Depending on the embodiment, the smart ring 405 may be configured in a manner similar or equivalent to any of the configurations 205a, 205b, 205c, 205d, 205e, and/or 205f or 305a, 305b, 305c, 305d, 305e, and/or 305f shown in FIG. 2 and FIG. 3.

The smart ring 405 may interact (e.g., by sensing, sending data, receiving data, receiving energy) with a variety of devices, such as bracelet 420 or another suitable wearable device, a mobile device 422 (e.g., a smart phone, a tablet, etc.) that may be, for example, the user device 104, another ring 424 (e.g., another smart ring, a charger for the smart ring 405, etc.), a secure access panel 432, a golf club 434 (or another recreational accessory), a smart ring 436 worn by another user, or a steering wheel 438 (or another vehicle interface). Additionally or alternatively, the smart ring 405 may be communicatively connected to a network 440 (e.g., WiFi, 5G cellular), and by way of the network 440 (e.g., network 105 in FIG. 1) to a server 442 (e.g., server 107 in FIG. 1) or a personal computer 444 (e.g., mobile device 106). Additionally or alternatively, the ring 405 may be configured to sense or harvest energy from natural environment, such as the sun 450.

The ring 405 may exchange data with other devices by communicatively connecting to the other devices using, for example, the communication unit 160. The communicative connection to other device may be initiated by the ring 405 in response to user input via the user input unit 170, in response to detecting trigger conditions using the sensor unit 150, or may be initiated by the other devices. The communicative connection may be wireless, wired electrical connection, or optical. In some implementation, establishing a communicative link may include establishing a mechanical connection.

The ring 405 may connect to other devices (e.g., a device with the charger 103 built in) to charge the battery 120. The connection to other devices for charging may enable the ring 405 to be recharged without the need for removing the ring 405 from the finger. For example, the bracelet 420 may include an energy source that may transfer the energy from the energy source to battery 120 of the ring 405 via the charging unit 430. To that end, an electrical (or optical) cable may extend from the bracelet 420 to an interface (e.g., interfaces 112a, 112b, 312a, 312b) disposed at the housing (e.g., housings 110, 210a, 210b, 210c, 210d, 210e, 210f, 210g, 210h, and/or 210i) of the ring 405. The mobile device 422, the ring 424, the golf club 434, the steering wheel 438 may also include energy source configured as chargers (e.g., the charger 103) for the ring 405. The chargers for may transfer energy to the ring 405 via a wired or wireless (e.g., inductive coupling) connection with the charging unit 130 of the ring 405.

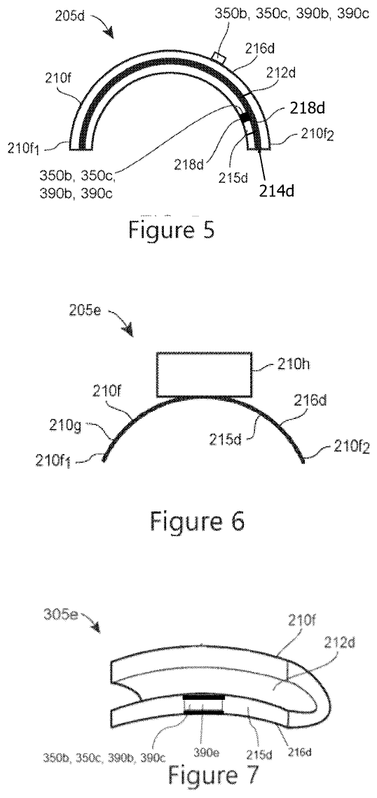

Referring now to FIG. 5, the smart ring 205d of FIG. 2 is depicted with some additional features. More specifically, the smart ring configuration 205d is a smart ring clip 205d including a body 210f. The body 210f includes a groove 212d for receiving a portion of a ring 214d, as depicted in FIG. 5. In addition, when a portion of the ring 214d is disposed within the groove 212d, as depicted in FIGS. 5 and 7, the portion of the ring contacts the body 210f to secure the ring 214d to the smart ring clip 205d. The portion of the ring 214d may be a smart ring, such as any of the foregoing described smart rings. Alternatively, the portion of the ring 214d may be a conventional ring without any smart features, for example.

In addition, the smart ring clip 205d may further include one or more of the battery 120, the charging unit 130, the controller 140, the processor unit 142, the memory unit 144, the sensor unit 150 comprising one or more sensors, the communications unit 160, one or more user input devices 170, or one or more output devices 190, each of which may be attached to or disposed within the body 210f. So configured, the body 210f may be secured to the portion of the ring 214d by the groove 212d, which clips onto the portion of the ring 214d when the smart ring clip 205d is disposed on the portion of the ring 214d. In addition, the body 210f of the smart ring clip 205d is removable from the portion of the ring 214d upon movement of the body 210f of the smart ring clip 205d in a direction away from the ring 214d.

As further depicted in FIG. 5, the body 210f of the smart ring clip 205d may further include a first end 210f1 and a second end 210f2 disposed opposite the first end 210f1. The groove 212d (shown in FIG. 7) may extend along the length, such as a circumferential length, of the body 210f of the smart ring clip 205f between the first end and the second end 210f1, 210f2. In addition, the body 210f includes an inside surface 215d (as shown in FIGS. 7) and 218d (as shown in FIG. 5) configured to contact the portion of the ring 214d and an outside surface 216d. The inside surface 215d, 218d may include the sensor 350b, 350c or the output element 390b, 390c. Each of the sensors 350b, 350c and the output elements 390b, 390c are previously defined above. Further, the body 210f may also include an outside surface 216d and the outside surface 216d may include one or more of the sensors 350b, 350c or the output elements 390b, 390c, each of which may be a surface element disposed on and in the same plane as the outside surface 216. Alternatively, the sensors 350b, 350c or output elements 390b, 390c may outwardly extend from the outside surface 216d of the smart ring clip 205d and still fall within the scope of the present disclosure.

As also depicted in FIG. 5, the body 210f of the smart ring clip 205d may include a partially annular shape, such as a partially circular shape or a semi-circular shape. While the body 210f is depicted as semi-circular in shape, the body 210f may alternatively be only partially semi-circular in shape, such as a portion of the semicircular shaped body 210f depicted in FIG. 5, and still fall within the scope of the present disclosure.

Referring now to FIG. 6, the smart ring configuration 205e of FIG. 2 is depicted with additional features. Specifically, the smart ring configuration 205e is another smart ring clip 205e with some features similar to the smart ring clip 205d of FIG. 5. For example, like the smart ring clip 205d, the smart ring clip 205e includes the body 210f having the first end 210f1 and the second end 210f2 disposed opposite the first end 210f1. In addition, the smart ring clip 205e also includes the inside surface 215d and the outside surface 216d. However, unlike the smart ring clip 205d of FIG. 5, the smart ring clip 205e includes a platform portion, such as a separate housing portion 210h, that is removably coupled to the outside surface 216d of the smart ring clip 205e. The housing portion 210h includes one or more of the one or more of the battery 120, the charging unit 130, the controller 140, the processor unit 142, the memory unit 144, the sensor unit 150 comprising one or more sensors, the communications unit 160, one or more user input devices 170, or one or more output devices 190. In addition, the like the smart ring clip 205d of FIG. 5, the body 210f of the smart ring clip may also include one or more of the battery 120, the charging unit 130, the controller 140, the processor unit 142, the memory unit 144, the sensor unit 150 comprising one or more sensors, the communications unit 160, one or more user input devices 170, or one or more output devices 190, each of which may be attached to or disposed within the body 210f. Further, the body 210f of the smart ring clip 205e may also include the substantially flat clip portion 210g configured to be attached to a conventional ring or a smart ring, such as one or more of the aforementioned and previously described smart rings.

Each of the foregoing smart ring clips 205d, 205e may include an electric sensor fabric material. For example, a portion of or the entire body 210f may include the electric sensor fabric. Additionally or alternatively, the body 210f may include silicone material configured to function as part of one of an artificial muscle or a nerve. The silicone material is capable of one or more of generating electricity or sensing pressure. Moreover, each smart ring clip 205d, 205e may be one of additively manufactured or heat molded according to dimensions of a ring to which the smart ring clip is to be coupled. Such dimensions may be obtained by one of scanning or photographing a portion of the ring or a mold indicative of the ring's dimensions, for example, as explained more below.

Referring now to FIG. 7, a cross-section view of a portion 305e of the smart ring clip 205d of FIG. 5 is depicted. The portion 305e includes the body 210f of the smart ring clip 205d, and a portion of the groove 212d. In this example, the groove 212d is rounded in shape, which corresponds to a typically rounded shape of the portion of the ring 214d, which is not depicted in this view, and to which the smart ring clip 205d is attached. The portion 305e of the smart ring clip 205d also includes the inside surface 215d and a surface element 390e. Here, the surface element 390e may include one or more of the sensors 350b, 350c or the output elements 390b, 390, each of which are previously defined above. Additionally and/or optionally, the surface element 390e may include an output device, such as an LCD display, OLED displays, e-ink displays, one or more LED pixels, speakers, and any other suitable output device that may be a part of a suite of outputs represented by the output unit, e.g., the output unit 190.

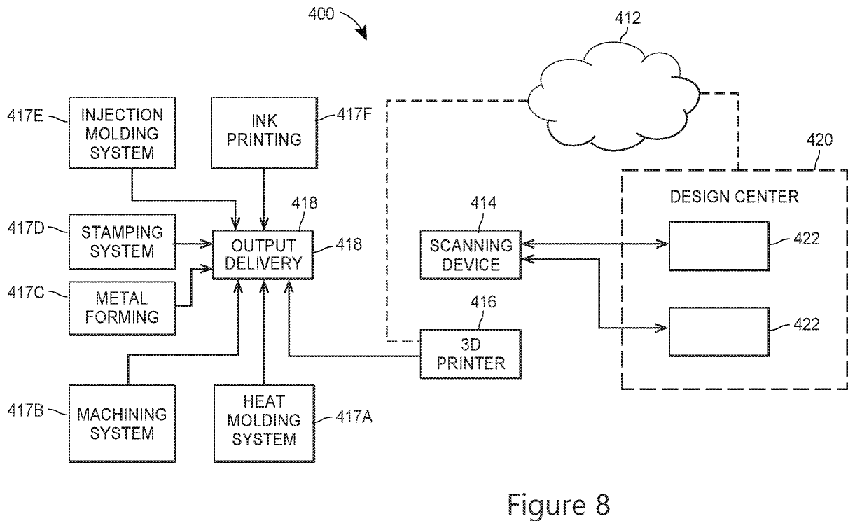

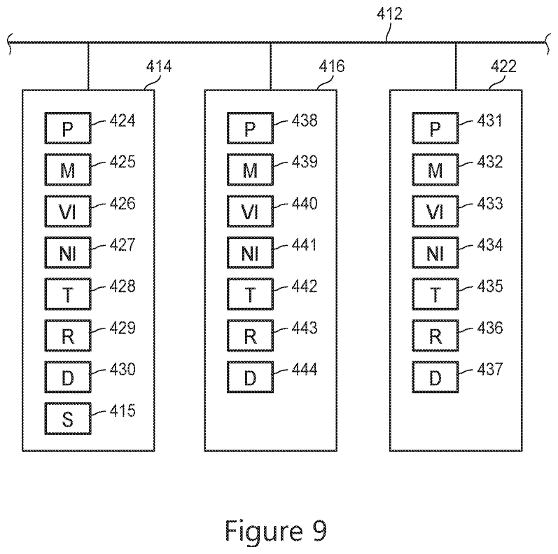

Referring now to FIG. 8, a system 400 for manufacturing any one of the foregoing smart ring clips is depicted. The system 400 includes a communication network 412, a scanning device 414 communicatively coupled to the communication network 412, such as a wireless network, and a design system 420 also communicatively coupled to the scanning device 414 and the communication network 412, as depicted in FIG. 8. The scanning device 414 scans a user's ring to create a ring-specific scan for the smart ring clip. The scanning device 414 may include one or more various known computing devices, such as an iPad, an iPod, an iPhone or any other smart phone, tablet or other device having such scanning capabilities, for example, and may further include a volumetric capture sensor 415 (FIG. 9). The ring-specific scan is later used to make the additively manufactured smart ring clip via a 3D printer, as described more below.

The system 400 further includes a 3D printer 416, which additively manufactures the ring-specific smart ring clip, and a delivery center 418 for delivery of final and complete additively manufactured smart ring clip. The system 400 further includes the design system 420 communicatively coupled to both the scanning device 414 and the 3D printer 416. In one example, the design system 420 is communicatively coupled via the communication network 421, such as wireless network 412. As depicted, the design system 420 includes one or more computing devices 422 that may receive data corresponding to a scan of the user's ring via the scanning device 414. At least one computing device 422 of the design system 420 then sends the ring-specific design to the 3D printer 416, such as via the wireless network 412, directing the 3D printer 416 to additively manufacture one of the foregoing smart ring clips according to the ring-specific design.

Alternatively and/or additionally, the system 400 for manufacturing any one of the foregoing smart ring clips may include a heat molding system 417A, a machining system 517B, a metal forming system 517C, a stamping system 517D, an injection molding system 517E, and/or an ink printing system 517F, each of which is coupled to the output delivery center 518 for delivery of the complete smart ring clip, as depicted in FIG. 8.

Referring now to FIG. 9, in one example, the scanning device 414 includes one or more processors 424 that implement a scanning module stored in a memory 425 of the scanning device 414 to scan a ring or a portion of a ring of the user. The scanning device 414 may also include a user-input 426 and a network interface 427, which allows the scanning device 414 to be communicatively coupled to the wireless network 412, for example, and communicate with the design system 420. The scanning device 414 further includes a transmitter 428 and a receiver 429, such that the transmitter 428 transmits scanned data corresponding to the ring-specific scan (e.g., of the ring of the user) to the design system 420 for processing, as explained more below. Further, the scanning device 414 may also include a display 430 on which the scanned data corresponding to the user's ring, for example, may be displayed.

In a similar manner, the one or more computing devices 422 of the design system 420 also includes one or more processors 431 that implement a module stored in a memory, such as a memory 432 of the computing device 422, to receive and process data corresponding to the ring-specific scan from the scanning device 414. The computing device 422 may also include a user-input 433 and a network interface 434, which allows the computing device to be communicatively coupled to the wireless network 421 and communicate with both the scanning device 414 and the 3D printer 416. The design system computing device 422 may also include a transmitter 435 and a receiver 436, such that the transmitter 435 transmits processed data relative to a ring-specific scan (e.g., from the scanning device 14) to the 3D printer 416, directing the 3D printer 416 to print a smart ring clip according to the ring-specific scan. The receiver 436 receives scanning data from the scanning device 414, which is processed by one or more processors 431 of the computing device 422 and used to implement the operation of the 3D printer 416. The computing device 422 also includes a display 437, on which data, such as data from the scanning device 414 and data processed by the computing device 422, may be displayed.

Still referring to FIG. 9, the 3D printer 416 is communicatively coupled to both the scanning device 414 and the design system 420. The 3D printer 416 includes one or more processors 438 that implement a ring-specific smart ring profile created and then transmitted from the computing device 422 of the design system 420 to the 3D printer 416 and stored in a memory 439 of the 3D printer 416. The ring-specific smart ring design profile that may be stored in the memory 439 of the 3D printer 416 includes a ring-specific design protocol for execution by one or processors 438 of the 3D printer 416. The 3D printer 416 may also include a user-input 440 and a network interface 441, which also allows the 3D printer 416 to be communicatively coupled to the wireless network 421, for example. The 3D printer 416 further includes a transmitter 442, a receiver 443 for receiving data from the design system 420 relative to a ring-specific smart ring profile, for example, and a display 444, which may include or be separate from the user-input 440.

Each of the processors 424, 431, and 438 may be a general processor, a digital signal processor, ASIC, field programmable gate array, graphics processing unit, analog circuit, digital circuit, or any other known or later developed processor. The processor 424 of the scanning device 414 may operate pursuant to a profile stored in the memory 425 of the scanning device 414, for example. The memory 425, 432, 439 may be a volatile memory or a non-volatile memory. The memory 425, 432, 439 may include one or more of a read-only memory (“ROM”), random-access memory (“RAM”), a flash memory, an electronic erasable program read-only memory (“EEPROM”), or other type of memory. The memory 425, 432, 439 may include an optical, magnetic (hard drive), or any other form of data storage.

In one example, the user-specific smart ring design protocol is part of the user-specific design profile stored on the memory 432, 439 and includes a set of executable instructions that controls the 3D printer 416 to print the ring-specific smart ring clip. The ring-specific smart ring clip design protocol may be stored on the memory 432, 439 as computing logic, which includes one or more routines and/or sub-routines, embodied as computer-readable instructions stored on the memory 432, 439. The processor 431, 438 can execute the logic to cause the processor 431, 438 to retrieve the profile and control the 3D printer 416 in accordance with the ring-specific smart ring clip design profile. In particular, the user-specific smart ring clip design protocol may specify, among other parameters, the size, shape and/or volume of the finger for the smart ring clip and the timing of the 3D printing.

In view of the foregoing, it will be understood that the foregoing described smart ring clips 205d and 205e may be manufactured according to the following method of manufacture. Specifically, the method is a method of manufacturing the smart ring clip 205d, 205e comprising creating the body 210f with a flexible material by one of heat molding, such as using a heat molding system 417 (FIG. 8), machining, such as using the matching system 417B, metal forming, such as using the metal forming system 417C, stamping, such as using the stamping system 417D, injection molding, such as using the injection molding system 417E, ink printing, such as using the ink printing system 417F, or additive manufacturing, using for example the 3D printer 416 (FIG. 8). The method further comprises creating the groove 212d disposed within the body 210f again by one of heat molding, machining, metal forming, stamping, injection molding, ink printing, or additive manufacturing. As explained above, the groove 212d is for receiving the portion of the ring 214d (FIG. 5), such that the portion of the ring 214d contacts the groove 212d when the smart ring clip 205d is clipped, e.g., attached to, the portion of the ring 214d. The method further comprises disposing one or more of the battery 120, the charging unit 130, the controller 140, the processor unit 142, the memory unit 144, the sensor unit 150, the user input unit 170 or the output unit 190 in or on one or more of the body 210f or the housing portion 210h separate from and coupled to the body 210f.

In another example, the method may further comprise coupling the housing portion 210h to the body 210f of the smart ring clip 205d, 205e, such as an additively manufactured body 210f of the smart ring clip 205d. The housing portion 210h may include one or more of the battery 120, the charging unit 130, the controller 140, the processor unit 142, the memory unit 144, the sensor unit 150, the user input unit 170 or the output unit 190. In another example, the method may further comprise disposing one or more of the sensor 350b, 350c or the output element 390b, 390c on the outside surface 216d of the body 210f. In yet another example, the method may further comprise disposing one or more of the sensor 350b, 350c or the output element 390b, 390c on the inside surface 215d of the body 210f.

In addition, creating the body 210f with a flexible material by one of heat molding, injection molding, ink printing, stamping, metal forming, machining, or additive manufacturing may comprise creating the body 210f with the flexible material and having one or more of a partially semi-circular shape, or a semi-circular shape. Further, creating the body 210f with flexible material by one of heating molding, injection molding, ink printing, stamping, metal forming, machining, or additive manufacturing may also comprise creating the body 210f having the first end 210f1 and the second end 210f2 and the inside surface 215d disposed between the first end and the second end 210f1, 210f2. Still further, creating the groove 212d disposed within the body 210f by one of heat molding, injection molding, ink printing, stamping, metal forming, machining, or additive manufacturing comprises creating the groove 212d extending between the first end and the second end 210f1, 210f2 along the length of the body 210f.

Several advantages of the foregoing smart ring clips will be appreciated. For example, by using the aforementioned flexible material for at least part of the body of the smart ring clip, the smart ring clip more flexibly attaches to the portion of the ring and is able to be more easily removed from the user. Further, by heat molding or additively manufacturing the foregoing smart rings, the smart ring clips are able to be customized to a user's exact ring dimensions for example, creating a better fitting smart ring clip for user comfort and satisfaction.

### Examples of Other Considerations

When implemented in software, any of the applications, services, and engines described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

The described functions may be implemented, in whole or in part, by the devices, circuits, or routines of the system 100 shown in FIG. 1. Each of the described methods may be embodied by a set of circuits that are permanently or semi-permanently configured (e.g., an ASIC or FPGA) to perform logical functions of the respective method or that are at least temporarily configured (e.g., one or more processors and a set instructions or routines, representing the logical functions, saved to a memory) to perform the logical functions of the respective method.

While the present disclosure has been described with reference to specific examples, which are intended to be illustrative only and not to be limiting of the present disclosure, it will be apparent to those of ordinary skill in the art that changes, additions or deletions may be made to the disclosed embodiments without departing from the spirit and scope of the present disclosure.

Throughout this specification, plural instances may implement components, operations, or structures described as a single instance. Although individual operations of one or more methods are illustrated and described as separate operations, one or more of the individual operations may be performed concurrently in certain embodiments.

As used herein, any reference to “one embodiment” or “an embodiment” means that a particular element, feature, structure, or characteristic described in connection with the embodiment is included in at least one embodiment. The appearances of the phrase “in one embodiment” in various places in the specification may not be all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements may not be limited to only those elements but may include other elements not expressly listed or inherent to such process, method, article, or apparatus. Further, unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. Generally speaking, when a system or technique is described as including “a” part or “a” step, the system or technique should be read to include one or at least one part or step. Said another way, for example, a system described as including a blue widget may include multiple blue widgets in some implementations (unless the description makes clear that the system includes only one blue widget).

Throughout this specification, some of the following terms and phrases are used.

Communication Interface according to some embodiments: Some of the described devices or systems include a “communication interface” (sometimes referred to as a “network interface”). A communication interface enables the system to send information to other systems and to receive information from other systems, and may include circuitry for wired or wireless communication.

Each described communication interface or communications unit (e.g., communications unit 160) may enable the device of which it is a part to connect to components or to other computing systems or servers via any suitable network, such as a personal area network (PAN), a local area network (LAN), or a wide area network (WAN). In particular, the communication unit 160 may include circuitry for wirelessly connecting the smart ring 101 to the user device 104 or the network 105 in accordance with protocols and standards for NFC (operating in the 13.56 MHz band), RFID (operating in frequency bands of 125-134 kHz, 13.56 MHz, or 856 MHz to 960 MHz), Bluetooth (operating in a band of 2.4 to 2.485 GHz), Wi-Fi Direct (operating in a band of 2.4 GHz or 5 GHz), or any other suitable communications protocol or standard that enables wireless communication.

Communication Link according to some embodiments: A “communication link” or “link” is a pathway or medium connecting two or more nodes. A link between two end-nodes may include one or more sublinks coupled together via one or more intermediary nodes. A link may be a physical link or a logical link. A physical link is the interface or medium(s) over which information is transferred, and may be wired or wireless in nature. Examples of physicals links may include a cable with a conductor for transmission of electrical energy, a fiber optic connection for transmission of light, or a wireless electromagnetic signal that carries information via changes made to one or more properties of an electromagnetic wave(s).

A logical link between two or more nodes represents an abstraction of the underlying physical links or intermediary nodes connecting the two or more nodes. For example, two or more nodes may be logically coupled via a logical link. The logical link may be established via any combination of physical links and intermediary nodes (e.g., routers, switches, or other networking equipment).

A link is sometimes referred to as a “communication channel.” In a wireless communication system, the term “communication channel” (or just “channel”) generally refers to a particular frequency or frequency band. A carrier signal (or carrier wave) may be transmitted at the particular frequency or within the particular frequency band of the channel. In some instances, multiple signals may be transmitted over a single band/channel. For example, signals may sometimes be simultaneously transmitted over a single band/channel via different sub-bands or sub-channels. As another example, signals may sometimes be transmitted via the same band by allocating time slots over which respective transmitters and receivers use the band in question.

Memory and Computer-Readable Media according to some embodiments: Generally speaking, as used herein the phrase “memory” or “memory device” refers to a system or device (e.g., the memory unit 144) including computer-readable media (“CRM”). “CRM” refers to a medium or media accessible by the relevant computing system for placing, keeping, or retrieving information (e.g., data, computer-readable instructions, program modules, applications, routines, etc.). Note, “CRM” refers to media that is non-transitory in nature, and does not refer to disembodied transitory signals, such as radio waves.

The CRM may be implemented in any technology, device, or group of devices included in the relevant computing system or in communication with the relevant computing system. The CRM may include volatile or nonvolatile media, and removable or non-removable media. The CRM may include, but is not limited to, RAM, ROM, EEPROM, flash memory, or other memory technology, CD-ROM, digital versatile disks (DVD) or other optical disk storage, magnetic cassettes, magnetic tape, magnetic disk storage or other magnetic storage devices, or any other medium which can be used to store information, and which can be accessed by the computing system. The CRM may be communicatively coupled to a system bus, enabling communication between the CRM and other systems or components coupled to the system bus. In some implementations the CRM may be coupled to the system bus via a memory interface (e.g., a memory controller). A memory interface is circuitry that manages the flow of data between the CRM and the system bus.

Network according to some embodiments: As used herein and unless otherwise specified, when used in the context of system(s) or device(s) that communicate information or data, the term “network” (e.g., the networks 105 and 440) refers to a collection of nodes (e.g., devices or systems capable of sending, receiving or forwarding information) and links which are connected to enable telecommunication between the nodes.

Each of the described networks may include dedicated routers responsible for directing traffic between nodes, and, optionally, dedicated devices responsible for configuring and managing the network. Some or all of the nodes may be also configured to function as routers in order to direct traffic sent between other network devices. Network devices may be inter-connected in a wired or wireless manner, and network devices may have different routing and transfer capabilities. For example, dedicated routers may be capable of high volume transmissions while some nodes may be capable of sending and receiving relatively little traffic over the same period of time. Additionally, the connections between nodes on a network may have different throughput capabilities and different attenuation characteristics. A fiberoptic cable, for example, may be capable of providing a bandwidth several orders of magnitude higher than a wireless link because of the difference in the inherent physical limitations of the medium. If desired, each described network may include networks or sub-networks, such as a local area network (LAN) or a wide area network (WAN).

Node according to some embodiments: Generally speaking, the term “node” refers to a connection point, redistribution point, or a communication endpoint. A node may be any device or system (e.g., a computer system) capable of sending, receiving or forwarding information. For example, end-devices or end-systems that originate or ultimately receive a message are nodes. Intermediary devices that receive and forward the message (e.g., between two end-devices) are also generally considered to be “nodes.”

Processor according to some embodiments: The various operations of example methods described herein may be performed, at least partially, by one or more processors (e.g., the one or more processors in the processor unit 142). Generally speaking, the terms “processor” and “microprocessor” are used interchangeably, each referring to a computer processor configured to fetch and execute instructions stored to memory. By executing these instructions, the processor(s) can carry out various operations or functions defined by the instructions. The processor(s) may be temporarily configured (e.g., by instructions or software) or permanently configured to perform the relevant operations or functions (e.g., a processor for an Application Specific Integrated Circuit, or ASIC), depending on the particular embodiment. A processor may be part of a chipset, which may also include, for example, a memory controller or an I/O controller. A chipset is a collection of electronic components in an integrated circuit that is typically configured to provide I/O and memory management functions as well as a plurality of general purpose or special purpose registers, timers, etc. Generally speaking, one or more of the described processors may be communicatively coupled to other components (such as memory devices and I/O devices) via a system bus.

The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A ring clip comprising:
a body;
a groove disposed within the body and extending along a length of the body between a first end and a second end of the ring clip, wherein:
the groove is configured to receive a ring having a conventional ring shape; and
the body of the ring clip is removable from the ring; and
a sensor configured to collect information from a user;
wherein a first portion of an outside surface of the body comprises a location that is:
outside of the groove; and
not configured to contact a finger of the user when the ring clip is coupled to the ring and when the ring is worn on the finger of the user; and
wherein a second portion of the outside surface of the body comprises a location that is:
outside of the groove; and
configured to contact the finger of the user when the ring clip is coupled to the ring and when the ring is worn on the finger of the user.

2. The ring clip of claim 1, further comprising a charging unit.

3. The ring clip of claim 1, wherein the outside surface of the body further comprises an output element.

4. The ring clip of claim 1, wherein the second portion of the outside surface of the body further comprises a sensor.

5. The ring clip of claim 1, wherein the first portion of the outside surface of the ring clip further includes a display.

6. The ring clip of claim 1, further comprising a user input unit.

7. The ring clip of claim 6, wherein the user input unit further comprises one or more of a button or a touch sensor.

8. A method of providing a ring clip, the method comprising:
providing a body;
providing a groove disposed within the body and extending along a length of the body between a first end and a second end of the ring clip, wherein:
the groove is configured to receive a ring having a conventional ring shape; and
the body of the ring clip is removable from the ring; and
providing a sensor configured to collect information from a user;
wherein a first portion of an outside surface of the body comprises a location:
outside of the groove; and
not configured to contact a finger of the user when the ring clip is coupled to the ring and when the ring is worn on the finger of the user; and
wherein a second portion of the outside surface of the body comprises a location that is:
outside of the groove; and
configured to contact the finger of the user when the ring clip is coupled to the ring and when the ring is worn on the finger of the user.

9. The method of claim 8, further comprising providing a charging unit.

10. The method of claim 8, wherein the outside surface of the body further comprises an output element.

11. The method of claim 8, wherein the second portion of the outside surface of the body further comprises a sensor.

12. The method of claim 8, wherein the first portion of the outside surface of the ring clip further includes a display.

13. The method of claim 8, further comprising a user input unit.

14. The method of claim 8, wherein the user input unit further comprises one or more of a microphone or a touch sensor.

15. A method of manufacturing a ring clip, the method comprising:
creating a body;
creating a groove disposed within the body and extending along a length of the body between a first end and a second end of the ring clip, wherein:
the groove is configured to receive a ring having a conventional ring shape; and
the body of the ring clip is removable from the ring; and
disposing a sensor configured to collect information from a user;
wherein a first portion of an outside surface of the body comprises a location that is:
outside of the groove; and
not configured to contact a finger of the user when the ring clip is coupled to the ring and when the ring is worn on the finger of the user; and
wherein a second portion of the outside surface of the body comprises a location that is:
outside of the groove; and
configured to contact the finger of the user when the ring clip is coupled to the ring and when the ring is worn on the finger of the user.

16. The method of claim 15, wherein creating the body of the ring clip comprises creating the body by additive manufacturing.

17. The method of claim 15, further comprising disposing an output element on the outside surface of the ring clip.

18. The method of claim 15, further comprising disposing a sensor on the inside surface of the ring clip.

19. The method of claim 15, further comprising disposing a display on the outside surface of the ring clip.

20. The method of claim 15, further comprising a user input unit.
